(19) United States
(12) Patent Application Publication
(10) Pub. No.: US 2002/0069693 A1
(43) Pub. Date: Jun. 13, 2002

(54) Apparatus and method for removal of oil or other waste liquid material from an oil filter unit associated with an internal combustion engine and production of an ecologically stable waste oil filter unit

(76) Inventor: Ram D. Bedi, Bloomfield Township, MI (US)

Correspondence Address: Andrew R. Basile, Young & Basile, P.C., Suite 624, 3001 West Big Beaver Road, Troy, MI, 48084, US

(21) Appl. No.: 09/880,482

(22) Filed: Jun. 13, 2001

Related U.S. Application Data
(60) Provisional application No. 60/254,185, filed on Dec. 8, 2000.

(51) Int. Cl. G01N 19/02; G01N 3/56

(52) U.S. Cl. 73/53.05; 73/10

(57) ABSTRACT

A method and apparatus for removing spent oil from an internal combustion engine and evacuating oil retained in an associated oil filter or filters which includes the steps of connecting an external, separable apparatus to the internal oil lubrication distribution system at a first point upstream of the oil filter, and at a second point in fluid communication with the oil reservoir; introducing a volume of purge gas in a manner sufficient to evacuate retained spent oil to the oil reservoir; and removing spent oil from the oil reservoir and measuring the amount removed.

### CROSS-REFERENCE TO RELATED APPLICATIONS

This Application claims the benefit of U.S. Provisional Application, Ser. No. 60/254,185, filed Dec. 8, 2000.

### BACKGROUND OF THE INVENTION

1. Field of the Invention

The invention relates to a apparatus and method for removing motor oil from an oil filter associated with an internal combustion engine. Such oil filters can be found in automobiles, trucks, tractors, heavy earth moving equipment, military equipment, or the like. More particularly, this invention relates to methods whereby spent or dirty oil can be expediently removed from the oil filter unit associated with an internal combustion engine and, optionally, analyzed as to volume and condition. Removal is accomplished in a manner which renders the oil filter ecologically stable and suitable for disposal or reprocess and reuse in an environmentally compatible and friendly manner.

2. Background of the Relevant Art

The benefits of routine oil changes in an internal combustion engine are well known. Routine oil changes have been shown to increase engine life and performance. With repeated prolonged use, motor oil builds up suspended particles, metallic and non-metallic, from the abrasive and adhesive wear of engine parts against one another and from products of incomplete combustion and improper air intake. The particles, in turn, cause abrasive wear of the engine bearings, piston rings and other moving parts and the reduction of the motor oil lubricity as various additives and lubricating components become depleted. This adversely affects engine performance and, if left unchanged, can destroy or cripple the engine performance. It is recommended by at least one oil manufacturer that the level of total solid concentration be limited to levels below 3.0% with levels of silica being present in amounts lower than 25 parts per million and sodium in amounts lower than 200 parts per million. Significant quantities of these contaminants are trapped and entrained in the oil filter unit or units associated with the internal combustion engine. However significant quantities are too small and escape such entrainment. These particles and contaminants tend to circulate thorough the engine during normal use.

To obtain satisfactory engine performance, and maintain solids concentration levels in the motor oil lower than the recommended 3.0%, changing the motor oil in an internal combustion engine is a necessary, but an undesirable, dirty and time-consuming task. In currently designed vehicles, the oil pan serves the purpose of a reservoir for circulation of engine oil. Engine lubrication is generally accomplished through a gear-type pump. The pump picks up engine oil from the oil pan sump, where oil is drawn up through the pick-up screen and tube, and passed through the pump to the oil filter. The oil filter is generally a full flow paper element unit. In some vehicles, an oil filter bypass is used to insure adequate oil supply, should the filter become plugged or develop excessive pressure drop. Oil is routed from the filter to the main oil gallery. The oil gallery supplies valve train components with oil, and by means of intersecting passages, supplies oil to the cam shaft bearings. Oil draining back from the rocker arms is directed, by cast dams in the crank case casting, to supply the cam shaft lobes. Oil also drains past specific hydraulic lifter flats to oil cam shaft lobes directly. The passages supplying oil to the cam shaft bearings also supply the crank shaft main bearings through intersecting passages. Oil from the crank shaft main bearings is supplied to the connecting rod bearings by means of intersecting passages in the crank shaft. The front cam bearing can include a slot on its outside diameter to supply oil to the cam sprocket thrust face. In some engines, many internal engine parts have no direct oil feed and are supplied either by gravity or splash from other direct feed components. A bypass valve can also be disposed in the oil pick-up screen to insure adequate oil flow if the screen should become restricted. A pressure regulator valve, sometimes located in the oil pump body, maintains adequate pressure for the lubrication system and bypasses any excess back to the suction side of the pump. Oil from the pump passes through the filter before going to the engine oil galleries. In the filter, the oil passes through a filtering element where dirt and foreign particles are removed.

To remove the contaminated oil, the drain plug, generally located in the lowermost region of the oil pan, is opened. The spent oil containing suspended particles is permitted to flow under gravity out of the pan into a suitable receptacle. After the spent oil is removed, the plug is replaced and fresh oil is added to the engine usually through a separate opening in the engine valve cover.

The oil removal and refill process is essentially the same whether performed at home, at service stations or at one of the various oil change centers which have opened in recent years. The flow rate, or time required for oil drainage, is the same for each of these locations, because it is limited by the size of the drain plug aperture and the force of gravity. Service stations and other locations simplify the process of oil drainage with the use of hydraulic racks, special oil collection receptacles and the like.

As a part of complete oil change procedures, the oil filter is typically removed and replaced. It has long been realized that oil filter effectiveness diminishes over time. Thus optimum engine performance warrants the periodic replacement of the engine oil filter or filters. Oil filter replacement is a messy and dirty operation as the filter itself acts as reservoir for oil. This contained material is prone to leakage and spillage during filter replacement operations. Thus spent oil which could be recycled and reused is lost. Additionally this spent oil contaminated or dirties the surrounding exterior of the internal combustion engine as well as the oil removal location and operator. Even small amounts of oils contained in the spent oil filter renders the filter unit prone to undesirable leakage and associated environmental contamination as it is being transported for recycle and reuse or proper disposal. This tendency toward contamination greatly increases to the handling, transportation and disposal costs associated with each spent oil filter unit. Thus great care must be taken to ensure that leakage and contamination of the surrounding environment does not occur at any time during or subsequent to the oil filter replacement procedures. Great care must also be exerted so that minimal or minor leakage does not occur which would adversely effect the aesthetic appreciation of the associated internal combustion engine. Additionally, the amount of oil contained in the waste oil filters represents a wasted natural resource which, if more easily collected could be recycled and reused. This could have positive impact on the financial situation of the vehicular operator and/or entity performing the associated oil change and filter replacement operation.

Regardless of the manner in which oil change is accomplished, it has long been appreciated that engine oil consumption and degradation can be indicative of engine performance and general engine condition. Excessive oil consumption can be indicative of engine problems such as malfunctioning piston rings, leaking and sagging exterior gaskets and seals or a lack of integrity in seals between the oil passages and coolant system. Information about specific increases in oil consumption would be of value to the vehicle owner to assist him in scheduling appropriate engine maintenance and repair before minor engine problems become major mechanical failures which compromise engine performance and engine life and introduce engine oil contaminants to be environment either as products of combustion or as leakage which can indiscriminately contaminate surfaces of the exterior engine compartment, as well as road and garage surfaces.

Environmental protection is a prominent social issue in our present society. Therefore, it would be desirable to encourage that oil removal be performed in the most environmentally safe manner possible. It is estimated that there are approximately 119 million privately owned passenger vehicles. These vehicles require approximately 360 million oil changes a year, using an average of 1.2 gallons per change based on an average oil change frequency of 2.94 times a year. This amounts to approximately 550 million gallons of motor oil changed per year. In the past, the vast majority of the oil is manually removed and collected in a variety of containers or receptacles, many of which are inappropriate for oil storage and containment. It has been estimated that 300 million gallons of oil a year seep into U.S. soil creating serious potential ground water pollution problems. It would be desirable environmentally and economically if this oil could be collected and recycled. Thus, it is desirable in the present invention to make the collection of oil during oil changes effortless, clean and inexpensive.

In establishing a system for encouraging oil recycling and resource recovery, it is also highly desirable to provide an system for spent oil removal which is self-documenting. By this, it is meant that the system is capable of accurately measuring and recording the amount of spent oil removed from various engines and the amount of fresh oil introduced into these engines. Accurate records of the amount of spent oil collected can be valuable in producing any waste manifests required under existing environmental protection and/or resource recovery laws.

Such records would provide regulatory agencies with an accurate indication of an oil handler's compliance with existing laws. The records would also be valuable to the operator of any oil change service by providing him with documentation demonstrating his adherence to all applicable laws and an opportunity to assist his customers in evaluating the need for overall engine maintenance.

Conservation of energy and the trade deficit are also major issues in today's society. It is estimated that 250-360 million gallons of spent oil can now be easily collected and profitably recycled. The price of spent oil so collected is four dollars per barrel at best, while the price of crude oil is much greater at approximately $18.00 per barrel. Recycling easily collected spent oil could decrease the trade deficit by approximately 120 million dollars, while providing a profitable recycling economy of approximately 86 million dollars per year.

Therefore, it would be desirable to provide a method which accelerates removal of spent oil completely and easily from the oil filter and the associated internal combustion engine. It would also be desirable to provide a system which reduces the amount of spent oil handling as required in conventional oil change operations. It would also be desirable to provide a system which effects removal of oil from oil filters and renders such filters ecologically stable with regard to spent oil leakage and pollution.

It would also be desirable to provide a system which permits accurate assessment of the amount and condition of oil expended and recovered. Finally, it is desirable to provide a method which could be easily employed by all vehicle owners at a convenient location with all the benefits of the method of the present invention such as time savings, money savings, convenience, minimum exposure to motor oil, environmental protection, energy conservation, trade deficit reduction, and finally longer lasting, better performing engines.

### SUMMARY OF THE INVENTION

The present invention includes an apparatus external and separable from the internal combustion engine and associated oil filter unit. The external device would be operably and removably connectable to waste oil storage means as well as to storage means which will contain any other purge liquids optionally used during the oil removal operations. The external apparatus includes air purge means for purging oil or other fluid retained with the oil filter element as well as any fluid remaining in the lubrication system passages of the internal combustion engine, such that all waste oil can be deposited in a suitable waste collection receptacle. The waste collection receptacle as contemplated herein may be an intermediate collection reservoir such as the oil pan reservoir present on the automotive vehicle or a permanent waste collection receptacle located external to the automotive vehicle for collecting and holding waste oil for further processing and disposal. In the preferred embodiment the device includes a suitable pump means which draws waste oil, which has preferably been collected in the oil pan into contact with suitable oil testing and measuring devices which record and optionally analyze the condition and amount of spent oil removed from an engine prior to its deposit in the appropriate waste storage or disposal device.

Once oil has been evacuated from the oil filter associated with the internal combustion engine, the oil filter may be removed and replaced with a fresh oil filter by any suitable manual or automated replacement means. If oil is evacuated and collected in the oil pan, the collected oil may be drawn into a suitable storage device, preferably in a automated manner.

In operation, the present invention provides a method for quickly and efficiently removing, measuring and recording the amount of waste oil present in an internal combustion engine. Additionally, the present invention provides purging of oil from the oil filter element of the internal combustion engine with pressurized air means.

This provides expedient and efficient means for purging oil from the oil filter element, and collecting purges oil in a manner which facilitates collect. The process renders the oil filter element ecologically stable with regard to waste oil leakage and contamination of the surrounding environment for an interval of sufficient length to, at minimum, position in the spent oil filter in a suitable over container.

Other modifications, characteristics, features and benefits of the present invention will become apparent upon reading the following detailed description of the invention in conjunction with the attached drawings.

### BRIEF DESCRIPTION OF THE DRAWINGS

In the following drawings, like reference numerals refer to like parts throughout the various views, wherein:

FIG. 1 is a schematic view of an oil removal apparatus according to the present invention;

FIG. 2 (5) is a perspective view of a remote oil filter and drain mounting bracket according to the present invention;

FIG. 3 (6) is a top view of the remote oil filter and drain mounting bracket;

FIG. 4 (7) is a bottom view of the remote oil filter and drain mounting bracket;

FIG. 5 (8) is a cross-sectional view of the remote oil filter and drain mounting bracket taken as shown in FIG. 3 (6);

FIG. 6 (9) is a cross-section view of the remote oil filter and drain mounting bracket taken as shown in FIG. 4 (7).

### DETAILED DESCRIPTION OF THE PREFERRED EMBODIMENT

The present invention is predicated on the unexpected discovery that oil removal operations which include a gas purge interval can produce used ecologically stable spent oil filters. Such ecologically stable spent oil filters are essentially oil free, i.e. containing sufficiently small volumes of oil such that the opportunity for spent oil leakage from the interior of the spent oil filter is minimized for an interval sufficient to remove the spent oil filter from association with an internal combustion engine and contain it in a suitable storage medium.

Heretofore compressed air and materials of the like have been used to promote the movement of spent oil collected in cavities located downstream of the oil filtration media located in the oil filter, through the associated engine oil distribution passages and into the oil pan or other suitable reservoir for collection and removal. It was believed that large portions of the spent oil contained in portions of the oil filter unit located upstream of the filtration media were largely unrecoverable due to the high solids concentration which collects in this region over the operational life of the oil filter unit. Such solids serve to coat and block the filtration medium preventing efficient traversal of oil through the medium. This phenomenon was exacerbated during introduction of purge gasses. During such intervals, the solids materials were driven into intimate contact with the filtration media further compounding eliminating already slow oil transit across the media. Thus while the introduced purge gas was capable of moving filtered spent oil from the interior of the oil filter unit, material on the unfiltered side was largely untouched as the purge gas sought the most expedient pathway through the compromised and burdened filter media.

Many attempts have been made to eliminate this problem. These have included direct mechanical removal of spent oil from the upstream side of the spent oil filter through specially produced orifices in the oil filter housing to introduction of various dilution media to promote movement of spent oil through the compromised filtration media.

The present invention is predicated on the unexpected discovery that the rapid introduction of a pulse of a suitable purge gas at an elevated pressure into the upstream portion of an oil filter can promote and initiate transfer of significant quantities of the spent oil through the filtration media and ultimately from the oil filter unit into the oil pan or suitable reservoir associated with the internal combustion engine. As indicated, heretofore, it as been widely held that pressurized gas could not be used to effect removal of spent oil from the oil filter by a path which included transit through the filtration media as it was believed that the elevated pressure associated with the purge gas tended to force the entrained solids in the spent oil into sealing contact with the associated filtration media thus blocking large areas of the filtration media. Thus an ecologically stable spent oil filter could not be produced relying on a method which encompassed introduction of purge gas upstream of the filtration media. Contrary to such widely held belief, the present invention is directed to a method for producing an ecologically stable spent oil filter which comprises the steps of introducing at least one pulse of pressurized purge gas into the interior of the oil filter unit containing a volume of spent oil while the spent oil filter is in fluid communication with an internal combustion engine, the introduction of the at least one pulse of purge gas occurring at a position upstream of the interface between the spent oil and the filtration media contained in the oil filer unit, urging spent oil through the filtration media ahead of and contemporaneous with the leading edge of the at least one pulse of pressurized purge gas, collecting the expelled spent oil in a suitable collection receptacle such as the oil pan, and then removing the spent oil filter from association with the internal combustion engine.

Without being bound to any theory, it is believed that the introduction of the at least one pulse of purge gas creates transient turbulent flow within the spent oil present up stream of the filtration media, particularly at the region proximate to the interface between the surface of the filtration media and the spent oil. This region of transient turbulent flow disturbs a sufficient portion of the entrained solid material from contact with the surface of the filtration media thereby relieving congestion for a brief interval sufficient to permit the transmission of spent oil though the filtration media and out of the spent filter unit. It is within the purview of this invention that a plurality of such pulses can be employed to maintain or recreate the turbulent state. Thus, quite unexpectedly, a method for removing quantities of spent oil contained in the spent or used oil filter has been discovered which eliminates the need for invasive or complex countercurrent evacuation of spent oil form the oil filter unit.

The duration of the pulse of introduced purge gas is an interval sufficient to maintain efficient transfer of the spent oil across the filtration media and out of the used oil filter unit. It is anticipated that this interval may vary from 0.1 sec to about five minutes depending on the performance of the filtration media and concentration of the contaminants entrained in the spent oil. Generally the purge gas will be introduced into contact with the oil filter unit and the spent oil contained therein at a pressure sufficient to convey the material across the filtration media efficiently but below a pressure level which will damage components of the associated internal combustion engine. Generally speaking the purge gas pressure will fall in a range between about 10% greater than ambient and 150% greater than ambient.

The spent oil unit which results from the process of the present invention is ecologically stable. As used herein the term “ecologically stable” is defined as a spent oil filter which does not emit or leak spent oil into the surrounding environment for and interval sufficient to transfer the spent oil filter unit from fluid contact with the internal combustion engine to a suitable containment device.

The basic process of the present invention can be employed successfully to remove oil from oil filter devices associated with internal combustion engines, particularly internal combustion engines having oil reservoirs and internal oil lubrication distribution passage systems. The term “internal oil lubrication distribution passage system” is defined as, but not limited to, the machined passages and circulation systems present in the engine block, cylinder head, crank shaft, cam shaft and connecting rods. Various engines will have differing lubrication requirements, and therefore, it is to be understood that every engine may not have the passages and circulation systems in all the enumerated components.

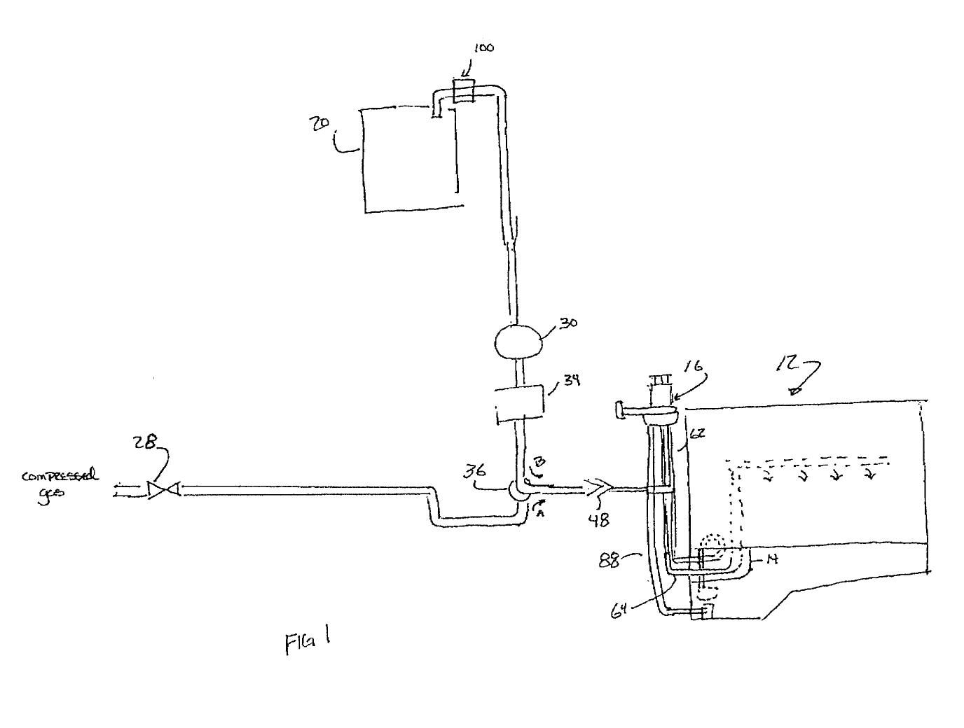

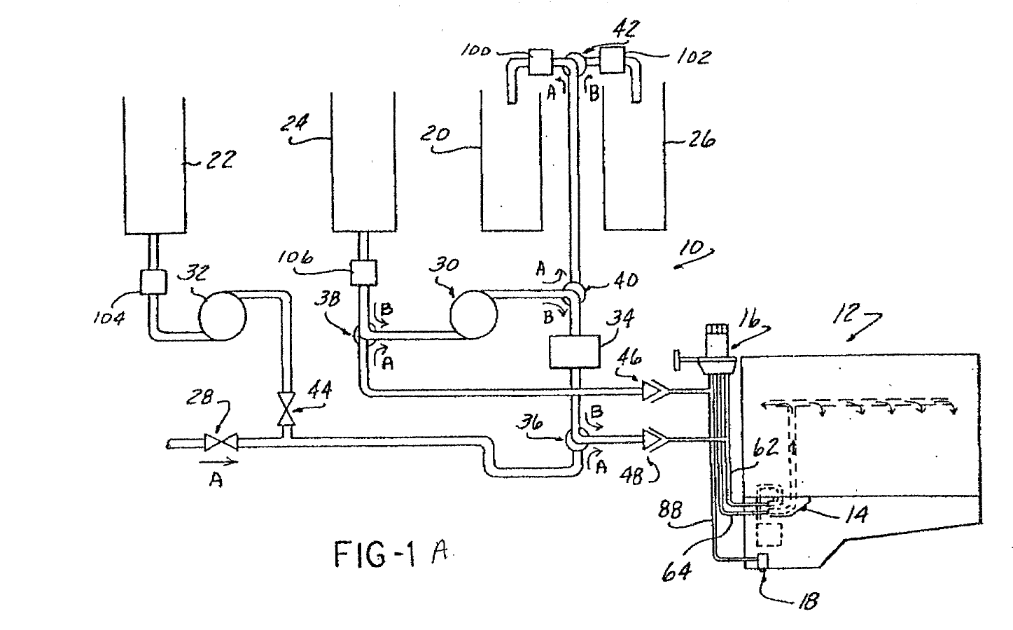

The present invention includes an oil changing apparatus, generally designated as 10, which is separable from an internal combustion engine generally designated as 12. The external, separable oil removal apparatus can be seen schematically on the left hand side of FIG. 1, while the internal combustion engine 12 is shown schematically on the right hand side of FIG. 1. As will be described in greater detail below, the present invention may include one or more adapters connected to the internal combustion engine 12 to facilitate proper connection of the external oil removal apparatus 10 to the lubrication system of the internal combustion engine 12. These adapters may be any suitable device which provides access upstream of the oil filter unit. The one or more adapters may include an oil filter mounting adapter 14, a remote oil filter and drain mounting bracket 16 and a drain plug adapter 18. One or more of these adapters may be required to modify existing internal combustion engines for use with the oil removal apparatus of the present invention. However, it is envisioned that at some point in time manufactures may modify the configuration of internal combustion engines to provide the appropriate coupling connections as required for the present invention as original equipment manufacturer's optional or standard equipment. Therefore, in its broadest sense, the present invention does not require the adapters disclosed in this application, but rather only requires a coupling connection capable of effecting removal of spent oil from the engine and associated engine parts, preferably in fluid communication with the lowermost portion of the oil pan reservoir and a second coupling connection in fluid communication with the internal oil lubrication distribution passage system, preferably between the oil pump and the oil filter element. It is also preferable that the coupling connections be provided with quick connect couplings as is conventional and known in the art.

Referring now to FIG. 1, the oil removal apparatus 10 of the present invention is connectable to a plurality of external storage means. The storage means may include a waste oil storage receptacle 20. In an optional configuration, the storage means may also include a flushing fluid supply receptacle 24 and a waste flushing fluid storage receptacle 26. The oil removal apparatus 10 also includes a connection to a source of compressed air or other suitable pressurized gaseous material. Connection to the source of compressed air is controlled by appropriate valve means 28 for opening and closing the communication of the compressed air with the oil removal apparatus 10.

The pressure at which the compressed air or other suitable gaseous material is supplied through the oil removal apparatus is controlled to prevent delivery of excessive pressure through the oil filter unit to the internal oil lubrication distribution passage system of the internal combustion engine. It should be recognized that the appropriate control circuitry for regulating the pressure of the compressed air is well known to those skilled in the art of compressed air delivery systems and is commercially available. It should also be noted that the compressed air delivered to the internal oil lubrication distribution passage system is preferably dried to minimize water vapor introduced into the internal oil lubrication distribution passage system which could cause problems with rust and degradation of any oil to be introduced into the internal oil lubrication distribution passage system of the internal combustion engine.

The oil changing apparatus 10 may also include pump means for evacuating spent motor oil from the internal combustion engine 14.

As depicted schematically in FIG. 1, the pump means may include a first pump 30 for drawing spent oil from the oil reservoir or other suitable location on the internal combustion engine 12 for discharge into the waste oil storage means 20.

Associated with the first pump 30 is a suitable mans for metering waste oil 100 capable of measuring the amount of spent motor oil removed from the internal combustion engine. The waste oil metering means 100 may be any suitable measuring device which can be integrated into or associated with the first pump 30 at a position upstream of waste oil storage means 20. Preferably the waste oil metering means 100 is any suitable volumetric measuring device which can provide a volumetric measurement of a continuous flow of a fluid such as motor oil.

The waste oil metering means 100 can be positioned at any location in the external pump device 10 suitable for monitoring the volume of spent oil removed from the associated engine 12. In FIG. 1 the waste oil metering means 100 is positioned proximate to the waste oil storage means 20. This position permits the metering means 100 to be dedicated to the measurement of waste oil. Alternately, the waste oil metering means 100 can be located at any position downstream of the associated engine 12 while a position downstream of pump device 30 is highly desirable to insure consistency in fluid pressure and flow rate.

The waste oil metering means 100 can include suitable control switches as well as data recording and transmission devices (not shown) to provide for monitoring, recordation and review of the amount of spent oil removed from a given vehicle. This data can be compiled to generate data on the amount of waste oil produced for storage, reclamation and/or disposal. Control switches are particularly desirable if the waste oil metering means is to be located in a fluid line which carries material other than spent oil to assist in distinguishing the true volume of spent oil passing through the device from the volume of flushing fluid being recirculated and/or removed from the associated engine 12. Such control switches can be employed to turn off the metering device or distinguish sources of fluid flow based on the chronology of the cleaning cycle or physical data such as viscosity picked up by any associated analytical probes or sensors.

Where accurate record of the volume of spent flushing fluid used is required, record of the volume of spent flushing fluid passing through the metering means 100 during the final removal of spent flushing fluid from the engine 14 can be recorded. Alternately, a separate dedicated metering means such as device 102 can be positioned upstream of and proximate to the waste flushing fluid storage means 26 as shown in FIG. 1.

The valve means can include a plurality of directional flow control valves. As shown in FIG. 1, the directional flow control valves are designated 36, 38, 40 and 42. Each of these directional flow control valves is operable to divert flow from a first direction indicated by arrow A to a second direction indicated by arrow B.

In operation, the internal combustion engine 12 is brought into proximity with the oil removal apparatus 10. A fluid conduit hose with a first quick connect coupling 46 is connected to the appropriate outlet connection of the internal combustion engine 12 for drawing fluid from the reservoir such as the oil pan of the internal combustion engine 12. Another hose with a second quick connect coupling 48 is connected to the appropriate connection of the internal combustion engine 12 for introducing gaseous material into the internal combustion engine 12 through the filter element and the internal oil lubrication distribution passage system of the internal combustion engine 12 for subsequent accumulation in the oil pan reservoir of the internal combustion engine 12. Directional flow control valve 36 is actuated to provide flow in the arrow A direction and valve means 28 is actuated to introduce pressurized air into the system to purge residual oil from the oil filter element thereby causing the residual spent oil retained within the filter element to be discharged through the internal oil lubrication distribution passage system to the oil pan reservoir of the internal combustion engine 12.

After completing the purging operation, control valve 28 is de-activated or closed to stop delivery of the compressed air. Directional flow control valve 38 is then operated to provide flow in the arrow A direction. Directional flow control valve 40 is also actuated to provide flow of fluid in the arrow A direction. In addition, directional flow control valve 42 is actuated to provide flow in the arrow A direction. Pump 30 is then energized to draw fluid from the oil pan reservoir of the internal combustion engine 12 for discharge into the spent oil storage receptacle 20. The fluid drawn from the oil pan reservoir is directed through metering means 100 for volumetric measurement and recordation prior to discharge into spent oil storage receptacle 20. The data collected from this measurement step can be formulated by appropriate mathematical operations to provide a variety of potentially useful information to the external pump device operator and/or the automobile owner. Such information can include the amount of spent oil withdrawn from an individual vehicle and the total amount of spent oil discharged into spent oil storage receptacle 20.

In the preferred embodiment, the external pump device 10 can include appropriate computing devices to store, record and display such volumetric information in a readily understandable form. It is within the purview of this invention to render such information in a form suitable for subsequent preparation of appropriate computer-generated manifests suitable for use in compliance with applicable environmental and hazardous waste disposal laws and ordinances.

The waste oil metering means 100 can also be equipped with various probes and sensors to collect and record data on the physical characteristics of the spent oil such as viscosity, lubricity and information regarding the concentration and characterization of contaminants and engine oil additives. This information can be analyzed against a collection of preprogrammed standards to provide a tool for the diagnosis of engine wear and performance. This information can be of great value as a diagnostic tool.

It is anticipated that such diagnostic information could be formulated in a printed form by an appropriate computer program or programs to provide the auto owner and mechanic with a read-out on oil condition and recommendations regarding future engine maintenance based on the condition of the removed spent oil.

In the process of the present invention, after the oil pan reservoir of the internal combustion engine 12 has been emptied, the pump 30 is de-energized. The filter element of the internal combustion engine 12 can be removed and replaced with a clean filter element during or after the emptying cycle as that has no effect on the emptying operation.

When the spent oil has been removed from the oil reservoir, the quick disconnect couplings 46 and 48 can be disconnected from the internal combustion engine 12. Fresh oil can then be introduced into internal combustion engine by any suitable manual or automated method subsequent to evacuation and removal of the spent material and replacement of the oil filter rendering the internal combustion engine 12 ready for normal use. If desired, the internal distribution passages and new oil filter can be precharged with fresh oil by any suitable method prior to engine start-up.

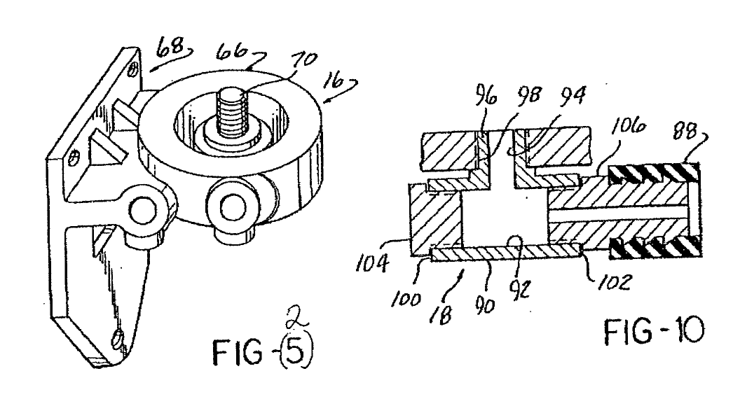

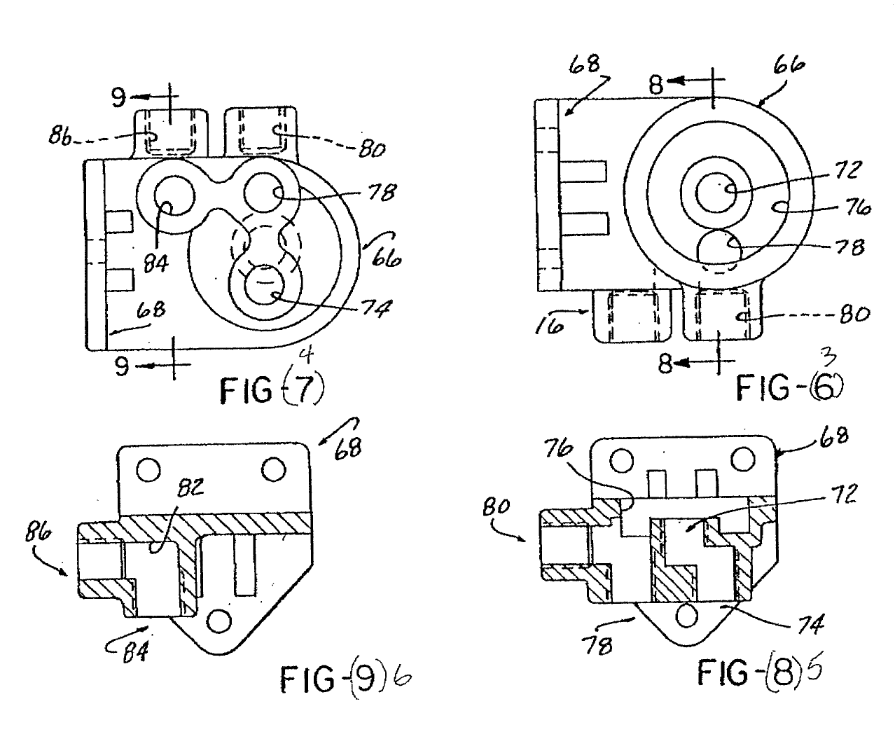

A remote oil filter and drain mounting bracket 16 is shown in detail in FIGS. 5-9. The remote mounting bracket 16 includes a filter mount portion 66 and a support bracket portion 68. The filter mount portion 66 includes a threaded nipple 70 for spinning on the filter element. The threaded nipple 70 is in fluid communication with a generally centrally disposed fluid passage 72 having a threaded external opening 74 adapted to receive a hose connection fitting for attachment to second hose 64.

Disposed around threaded nipple 70 is an annular fluid passage groove 76 in fluid communication with a threaded external opening 78 adapted to receive a hose connection fitting for attachment to first hose 62. First hose 62 is also in fluid communication with a quick connect coupling for attachment to the external oil changing apparatus 10 of the present invention. The fluid connection to the first hose 62 can be made anywhere along the length of the fluid passage between the remote mounting bracket and the engine block, however, the preferred embodiment of the present invention provides a second external opening 80 in fluid communication with the annular fluid passage groove 76 of the remote mounting bracket 16. The second external opening 80 is adapted to receive a portion of the quick connect coupling which can be mounted on the remote mounting bracket providing a conveniently located support for connection to the external oil changing apparatus 10. It should be apparent that the second external opening 80 must be adequately sealed during operation of the internal combustion engine 12. It is envisioned that the quick coupling connection attached to the second external opening 80 would be of the self-sealing type, such that when the separable external oil changing apparatus 10 is not connected to the internal combustion engine 12, the portion of the quick coupling connection attached to the external opening 80 would be self-sealed, or in the alternative could be provided with an appropriate sealing end cap or plug.

Optionally, the filter mount portion 66 of the remote mounting bracket 16 can also include a third fluid passage 82 with first and second external openings 84 and 86 respectively. The first external opening 84 of the third fluid passage 82 is adapted to receive a hose connection fitting for connection to a third hose 88. The opposite end of the third hose 88 is connected to a drain plug adapter 18 which will be described in greater detail below. The second external opening 86 of the third fluid passage 82 is adapted to receive a portion of a second quick connect coupling for attachment to the external oil changing apparatus 10. As previously described, the quick connect couplings 46 and 48 are known in the art and commercially available. Preferably, each quick connect coupling 46 and 48 is separable into two portions, one of which is permanently mounted in the engine compartment and preferably self-sealing. The other portion of the quick connect couplings 46 and 48 is connected to the hose lines extending from the external oil changing apparatus 10 providing connections between the apparatus 10 and the internal combustion engine 12. This configuration of the remote mounting bracket 16 is the preferred embodiment, since it provides a central location for all connections to the external oil changing apparatus 10 and also supports the filter element in the same central location in a readily accessible position for easy replacement.

It should be recognized however that the present invention also includes within its scope separate remote mounting brackets one for mounting the oil filter and another one for supporting the quick connect couplings at a location spaced from the oil filter, if desired or necessary within the particular engine compartment being modified. In this particular instance, the external openings 80 and 86 could be adapted to receive hose connection fittings for attachment to the remote quick coupling connection mounting bracket. In addition, it should be recognized that the third hose 88 could be led directly to the remote quick coupling mounting bracket without passing through the remote mounting bracket of the oil filter. Furthermore, as previously mentioned, the fluid connection to the first hose 62 can be made anywhere along the fluid passage between the oil filter mounting adapter and the remote oil filter mounting bracket and can lead directly to the remote quick coupling connection bracket.

A drain plug adapter 18 is shown in FIG. 10. The drain plug adapter 18 includes a body member 90 having a central through bore 92 extending therethrough and a branch through bore 94 which is in fluid communication with central through bore 92 and is angularly orientated thereto. Branch through bore 94 may have an externally threaded male first end 96 adapted to matingly engage within the internally threaded female aperture 98 formed in the bottom of the oil pan reservoir of the internal combustion engine 12.

In the alternative, an internally threaded end of branch bore 94 may be adapted to receive a portion of an externally threaded male connecting member therein. The connecting member may include a first externally threaded region adapted to be threadingly received in the internally threaded end of branch bore 94 and a second externally threaded region adapted to be threadingly received in the drain plug opening 98 of the oil pan reservoir of the internal combustion engine 12. To facilitate attachment of the drain plug adapter 18 in the drain plug opening 98, the connecting member may have a centrally positioned square or hexagonal shaped portion adapted to be engaged by known tools for turning the connecting member to threadingly engage within the aperture 98 of the oil pan reservoir and branch through bore 94 of the drain plug adapter 18. The connecting member, of course, would have a through bore longitudinally extending therethrough to bring the oil pan interior into fluid communication with the branch through bore 94 and the central through bore 92.

The central through bore 92 of the drain plug adapter 18 has first and second ends, 100 and 102 respectively. One end of the central through bore is adapted to receive a drain plug 104. The other end of the central through bore is adapted to receive a hose connection fitting 106. Preferably, the hose connection fitting 106 is a push-on type hose connection fitting adapted to sealingly engage an end section of hose without requiring the use of hose clamps, as is commercially available and known in the hose connecting art. The third hose 88 is attached to the drain plug adapter 18 at the outlet of central through bore 92.

While the invention has been described in detail, it will be apparent to those skilled in the art that the disclosed invention may be modified. Therefore, the foregoing description is to be considered exemplary, rather than limiting and the true scope of the invention is that defined in the following claims.

What is claimed is:

1. A method for evacuating oil from an oil filter associated with an internal combustion engine having an internal oil lubrication distribution passage system with an oil filter and an oil reservoir, the method comprising the steps of:
connecting an external, separable apparatus to said internal oil lubrication distribution passage system at a first point upstream of said oil filter, and at a second point in fluid communication with said oil reservoir;
evacuating spent oil from said oil filter into said oil reservoir;
removing accumulated spent oil from said oil reservoir;

2. The method of claim 1 further comprising the steps of:
determining the viscosity and lubricity of said spent oil removed from said oil reservoir;
comparing said determined values of viscosity and lubricity against known standard values; and
calculating deviation from said values.

3. The method of claim 2 further comprising the steps of:
determining presence and concentration of chemical breakdown products of oil and oil additives present in said spent oil; and
reporting said presence of said breakdown products.

4. The method of claim 3 further comprising the steps of:
determining presence and concentration of foreign contaminants present in said spent oil; and
reporting presence of foreign contaminants.

5. The method of claim 1 further comprising the steps of:
introducing said measured amount of spent oil removed from said oil reservoir into a suitable environmentally safe storage facility;
recording said measured amount value on a suitable recording document.

6. An apparatus for removing spent oil from an oil filter unit associated
with an internal combustion engine, the internal combustion engine having an internal oil lubrication distribution passage system with an oil pump, and oil filter and an oil reservoir, the apparatus comprising;
purge gas supply passage means disengagably connected to the internal combustion engine at a point between said oil pump and said oil filter, the purge gas supply means capable of delivering a volume of purge gas sufficient to evacuate spent oil from the oil filter to said oil reservoir;
oil withdrawal passage means having a disengagable fluid connection in fluid communication with a lowermost portion of said oil reservoir of said internal combustion engine;
first oil discharge passage means connectable with an external spent oil storage receptacle;
means for measuring oil volume passing through said first oil discharge passage means; and
valve means for selectively connecting said fluid supply passage means to said internal combustion engine with said outlet passage means of said pump downstream from said second valve means and for connecting fluid supply passage means to said internal combustion engine with said compression air supply passage means.

7. A method for producing an ecologically stable spent oil filter comprising the steps of:
introducing at least one pulse of pressurized purge gas into the interior of the oil filter unit containing a volume of spent oil while the spent oil filter is in fluid communication with an internal combustion engine, the introduction of the at least one pulse of purge gas occurring at a position upstream of an interface between the spent oil and filtration media contained in the oil filer unit;
urging spent oil through the filtration media ahead of and contemporaneous with the leading edge of the at least one pulse of pressurized purge gas;
collecting spent oil expelled form the spent oil filter unit in a suitable collection receptacle such as the oil pan, and then
removing the spent oil filter from association with the internal combustion engine.
